(19) United States
(12) Patent Application Publication
(10) Pub. No.: US 2013/0030779 A1
(43) Pub. Date: Jan. 31, 2013

(54) PREDICTIVE AND CLOSED LOOP CHANGE MANAGEMENT OR INNOVATION ACCEPTANCE PLATFORM

(71) Applicant: Benjamin Patrick Leonard, Plymouth, MN (US)

(72) Inventor: Benjamin Patrick Leonard, Plymouth, MN (US)

(21) Appl. No.: 13/561,745

(22) Filed: Jul. 30, 2012

Related U.S. Application Data
(60) Provisional application No. 61/513,576, filed on Jul. 30, 2011.

(51) Int. Cl. G06N 5/00; G06G 7/48; G06F 17/00

(52) U.S. Cl. 703/6; 706/45; 706/46

(57) ABSTRACT

Embodiments of the invention include systems and methods for accelerating or improving the success rate of a behavior change in an organization, group or community. In an embodiment, the invention includes a method for accelerating or improving the success rate of a behavior change, the method including gathering primary and secondary relationship data of an informal network of individuals and behavior change constructs for a plurality of individuals within the informal network of individuals; performing social network analysis of the informal network; and performing statistical perception analysis of the individuals within the informal network. In an embodiment, the invention includes a system for accelerating or improving the success rate of a behavior change initiative in an organization, group or community. Other embodiments are also included herein.

This application claims the benefit of U.S. Provisional Application No. 61/513,576, filed Jul. 30, 2011, the content of which is herein incorporated by reference in its entirety.

### FIELD OF THE INVENTION

The present invention relates to systems and methods for accelerating or improving the success rate of a behavior change in an organization, group or community.

### BACKGROUND OF THE INVENTION

Innovation has been shown to be key driver of corporate success; this is especially true for younger companies whose growth comes from finding new markets with innovative new products. The acceptance of new innovations or new technologies such as information systems is also becoming more critical in the competitive global environment.

### SUMMARY OF THE INVENTION

Embodiments of the invention include systems and methods for accelerating or improving the success rate of a behavior change in an organization, group or community. In an embodiment, the invention includes a method for accelerating or improving the success rate of a behavior change, the method including gathering primary and secondary relationship data of an informal network of individuals and behavior change constructs for a plurality of individuals within the informal network of individuals; performing social network analysis of the informal network with a computing system using the gathered primary and secondary relationship data and behavior change constructs; and performing the statistical perception analysis of the individuals within the informal network using gathered primary and secondary relationship data and behavior change constructs; wherein the behavior change constructs include at least one of change perception, behavior intention, and behavior measures.

In an embodiment, the invention includes a system for accelerating or improving the success rate of a behavior change initiative in an organization, group or community, the system including a processor; and memory in operative communication with the processor; the system configured to process as input primary and secondary relationship data of an informal network of individuals and behavior change constructs for a plurality of individuals within the informal network of individuals; the system configured to perform social network analysis of the informal network using the gathered primary and secondary relationship data and behavior change constructs; and the system further configured to perform perception analysis of the individuals within the informal network using the gathered primary and secondary relationship data and behavior change constructs; wherein the behavior change constructs include at least one of change perception, behavior intention, and behavior measures.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE FIGURES

The invention may be more completely understood in connection with the following drawings, in which:

FIG. 1 is a schematic logical component view of the system which includes a database, potential interfaces to other systems, and the components that make up the functionality in some embodiments.

FIG. 2 is a schematic generalized network view of the application and system used on a computer and across a network in accordance with some embodiments.

FIG. 3 is a schematic view of the computer that the application resides on in accordance with some embodiments.

FIG. 4 is a flow chart showing exemplary detailed operations in the assessment functionality in accordance with various embodiments.

FIG. 5 is a flow chart showing exemplary detailed operations in the feedback and recommendation functionality in accordance with various embodiments.

FIG. 6 is a flow chart showing exemplary detailed operations in the implementation functionality in accordance with various embodiments.

FIG. 7 is a flow chart showing exemplary detailed operations in the evaluation functionality in accordance with various embodiments.

FIG. 8 is a flow chart showing exemplary operations of a method and/or the configuration of a system in accordance with various embodiments herein.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The embodiments of the present invention described herein are not intended to be exhaustive or to limit the invention to the precise forms disclosed in the following detailed description. Rather, the embodiments are chosen and described so that others skilled in the art can appreciate and understand the principles and practices of the present invention.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Change management or behavior change initiatives create issues for organizations who need to be able to successfully implement them to gain the potential benefits or return on investment. For example, within organizations, older technologies and processes are continually being replaced by new innovations. Examples of innovations include, but are not limited to changes such as new technologies, wellness programs, engagement programs, innovation programs, recognition programs and systems, sales incentive systems, or significant business process changes. Innovations can be pursued to drive improved productivity or deliver new services, but they are only successful when the employees or participants accept and effectively use the new technology. Thus many innovations also fail due to the lack of acceptance and usage by employees or participants.

Management of behavior change initiatives for groups has been evolving and shown to be heavily influenced by psychological factors such as social influence, perceived usefulness or ease of use, enjoyment and habits. Regardless of this new knowledge on how people perceive change, common approaches and systems to manage change or innovations are traditionally focused on up-front roll-out plans, communication plans, training plans, and other facilitating conditions such as a help-desk, and deploying subject matter experts with little concern of the individual or group psychological factors. This traditional approach only provides the planners with a limited understanding of the potential participant's needs, the influences of their informal social network connections, or physiological perceptions of the new innovation or change initiatives.

Organizational Change, Technology Acceptance, and Social Network Analysis research is advancing and rich network data is becoming easier to gather, but its complexity is prohibitive to implementation by practitioners managing change. By not accounting for this rich network data, current approaches are resulting in sub-optimal deployment of resources and money to manage change, higher levels of failure, and sub-optimal return on investment in new innovations.

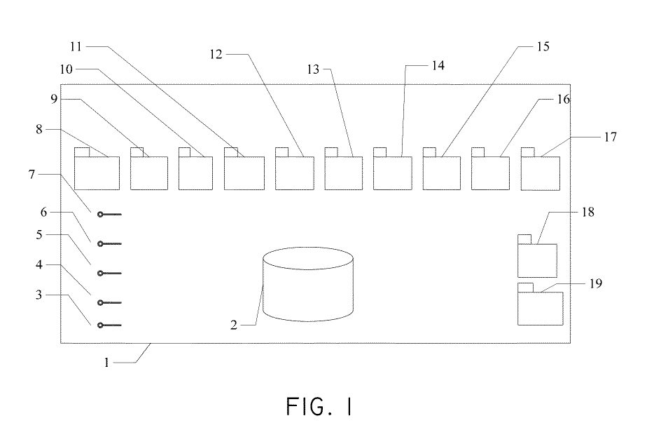

Referring now to FIG. 1, a schematic logical component view of a system in accordance with various embodiments herein is shown which includes a database, potential interfaces to other systems, and the components that make up the functionality. In specific, there is shown a system 1 with a database 2, a component to manage program/campaigns 8, a component to manage participants/groups/attributes 9, a component to gather primary data 10, a component to run social network analysis 11. In FIG. 1 there is also shown a component to run perception analysis 12, a component to auto-recommend change roles 13, a component to manually select and assign change/innovation roles 14, a component to auto-recommend training, communications & facilitating conditions 15, a component to manually select and configure training, communications, and facilitating conditions 16, a component to simulate change/innovation acceptance longitudinally over time 17, a component to monitor change 18, and a component to manage a cost and benefit calculator 19. These components or modules can represent a configuration of a system as implemented across one or more computing devices. In FIG. 1 there is also shown components or interfaces to external systems or data feeds which include an external data interface 3, an external statistics interface 4, an external survey tool interface 5, and external social network analysis interface 6, and an external change/innovation system usage interface 7.

In more detail, still referring to an embodiment of FIG. 1, the database 2 contains, but is not limited to, the necessary data to execute the functionality of the components 8 to 19 which can include, but is not limited to participants, groups, participant attributes, change/innovation perceptions, social network connections which are also referred to as dyads, participant network attributes such as centrality or group membership. The database 2 could also contain a repository of training, communications, facilitating conditions and their impacts.

In further detail, still referring to an embodiment in FIG. 1, the component to manage programs/campaigns 8 can have the functionality to, but is not limited to, manage templates of different types of changes or new innovation initiatives which could act as starting points for planning, simulation, managing, and monitoring. This component to manage programs or campaigns 8 also allows the selection of permissions and access for users of the system for a particular program or campaigns.

In further detail, still referring to an embodiment in FIG. 1, the component to manage participants, groups, and attributes 9 can be used to allow creating, viewing, updating, and deleting of the participants who are targeted for the new change or innovation. This also includes removing duplicates or managing additional previously unknown participants who were forwarded a survey or identified during the process of gathering primary connection data from the targeted participants of the behavioral change initiative.

In further detail, still referring to an embodiment in FIG. 1, the component to gather primary data 10 can be used to gather perceptions, network connections, and actual usage information. The perceptions could include the ability to configure online surveys to gather perceptions using previously validated or new scales based on areas such as usefulness, ease of use, social influence, or habits, behavioral intention, and actual usage. The network connections could include survey questions asking for whom the individuals they go to for different modes such as help, information, resources and others. Actual usage of a system or innovation could be gathered in this section via a survey question, manually entering it, a file import or integration to a separate system such as usage logs.

In further detail, still referring to an embodiment in FIG. 1, the component to gather primary data 10 can also be able to track responses, view respondents, offer incentives to complete the survey, and manage messaging. Since all the connections or targeted participants for a change or innovation initiative might not be known at the beginning of the initiative, this component also includes functionality to configure “snowball survey” options, which essentially allows the system to discover connections to unknown participants (i.e. outside of the organization or target group) via the surveys, then follow up with an additional survey to the new participant.

In further detail, still referring to an embodiment in FIG. 1, the component to run social network analysis 11 can be used to create the social network models and their attributes based on the primary and other data available to the system. Social Network Analysis uses a combination of theories and algorithms building upon Graph Theory such as Centrality in Social Networks by Freeman in 1979, or Structural Hole Theory by Burt in 1992, or Graph Theory & Group Structure by Harary in 1965. This could include natural groups of the organizations which need to be identified to bring close groups through change together (i.e. determine training groups). An example of using social network analysis can be found in Sykes et al., 2009, Model of Acceptance with Peer Support: A Social Network Perspective to Understand Employees System Use, MIS Quarterly, (33:2) pp. 371-393. Social network analysis can be used to determine the boundaries of an informal network, factions, cliques, natural groups, structural hole positions, opinion leaders, isolates, and network attributes such as centrality.

In further detail, still referring to an embodiment in FIG. 1, the component to run perception analysis 12 can be used to run a statistical analysis of the perceptions of the group as well as merge the results with the social network analysis results. This allows the change or innovation planners to view the actual perceptions overlaid onto the social networks of the organization. This allows the planners to view the perceptions and actual usage of the innovation at aggregate group or individual level. These perceptions are also used to determine the appropriate training and communication treatments (i.e. target hands-on technical training to those with low perceived ease of use perceptions). The system also calculates the perception metrics of a person's neighborhood in the informal networks which is used to help predict participants own perceptions and future usage

In further detail, still referring to an embodiment in FIG. 1, the component to recommend change roles 13 can be used to identify subject matter experts or super-users based on their centrality of different network modes. For example, if there are certain people that everyone goes to for help, they would be an ideal candidate to be a subject matter expert. This component can also recommend training groups based on the natural groups which allows tight-knit groups to go through acceptance or adoption of the change or innovation together. Isolates or individuals who are not connected to the informal networks can also be identified as part of the social network analysis. The analysis results enable better targeting of training and communications based on the informal network structure and positions. The system can also identify how to improve the network structure to increase the speed of change, for example, aligning subject matter experts with isolates or building connections between natural groups. This component can also recommend participants who should be targeted for communication or events like team-events to increase the number of connections they have for getting help, information, and knowledge around the change or innovation. One objective of this social network analysis can be to recommend specific actions that can maximize the effectiveness of the coping and influencing networks.

In further detail, still referring to an embodiment in FIG. 1, the component to select and assign change and innovation roles 14 can be used to view the recommendations generated from component 13, then make any adjustments to the assignments of subject matter experts, training & communication groups, and super-participants/isolate pairings. The system user can view opinion leaders and groups based on the social network analysis. This allows them to view who has the most influential power regarding multiple modes of the change (i.e., where do they go for help, who has access to resources, information, domain knowledge, or other modes). Those with high centrality should be incorporated as SMEs into the change or innovation initiative. This component allows the system user to view groups, factions, and auto-generated suggested training groups

In further detail, still referring to an embodiment in FIG. 1, the component to recommend training, communications, and facilitating conditions 15 can be used allow the system to auto-generate training and communication plans. The system can choose the best communication and training options based on previously validated research results and similar initiatives. These are auto-generated appropriate communication and training for each individual and groups to maximize intention and usage where each participant could be different based on their perceptions, group membership, centrality, and moderating effects such as experience, and voluntariness of the change or innovation.

In further detail, still referring to an embodiment in FIG. 1, the component to select and configure training, communications and facilitating conditions 16 can be used to view the recommendations from the system and select from a list of training and communication treatments which can impact participant's perceptions, intentions, and usage. The potential impact of the communication and training options are based on prior published research, previous calibration via testing, or expert estimate. Impacts are categorized similar to the main constructs for change and innovation acceptance based on published research, previous testing, or expert estimate (usability, ease of use, facilitating conditions, social influence, habits). The system user can select from a list of facilitating conditions offered (help desk, online help, and others). New training options, communications, training and facilitating conditions can also be added by the system user. This is needed in some embodiments because most large behavioral change initiatives will have suggested roll-out activities. This could also include configuring incentives, such as giving an incentive to the first segment of participants that go through training To facilitate simulation of the acceptance of this change or innovation later, the timing of the training, communications, or facilitating conditions can be entered prior to using the simulation component 17.

In further detail, still referring to an embodiment in FIG. 1, the component to simulate change and innovations longitudinally over time 17 can be used to quickly simulate multiple change and communication plans over-time across the networks and view the effectiveness of the different plans. In configuring the scenario for simulations, the system user can configure the target perceptions, intention, and usage which would be considered success. This allows the system user to adjust communication, training, or facilitating conditions as needed until they are satisfied with the results. The simulations can take into account the particular subject matter experts, change in perceptions over a series of times steps, network neighbor perceptions, network neighbor intentions, network neighbor usage, training, communications, centrality, moderating affects, facilitating conditions, and others. The simulations can be re-run using multiple scenarios based on a range of a particular variable or configuration

In further detail, still referring to an embodiment in FIG. 1, the component to monitor the change or innovation initiative 18 can be used to view reports or dashboards of relevant change metrics such as usage, perceptions, effectiveness of communications and training treatments based on the most current data. Periodic surveys are one way that a current status is maintained of the perceptions and usage. Actual system usage logs of a new technology or innovation are another source of information for these dashboards that could imported through an external data interface 3.

In further detail, still referring to an embodiment in FIG. 1, the component to monitor the change or innovation initiative 19 can be used to calculate a cost-benefit comparison of the overall change or innovation initiative. This calculation uses the estimated or actual costs of the communication, training, and facilitating condition treatments and additional participant entered data such as benefits, participant hourly costs, and others.

In further detail, still referring to an embodiment in FIG. 1, the component that is an external data interface 3 can be used to integrate to an external system via real-time or batch file to access other participant attributes, connections, or affiliations. These could include email systems, social media applications such as Facebook or LinkedIn, HR systems or others.

In further detail, still referring to an embodiment in FIG. 1, the component that is an external statistics interface 4 can be used to run statistical processing such as perception descriptive statistics or regressions using a standard statistics package such as IBM's SPSS.

In further detail, still referring to an embodiment in FIG. 1, the component that is an external survey tool interface 5 can be used to gather perceptions, network connections, and other attributes.

In further detail, still referring to an embodiment in FIG. 1, the component that is an external social network analysis 6 can be used to perform social network analysis calculations, transformations, and render social network graphs.

In further detail, still referring to an embodiment in FIG. 1, the component that is an external change or innovation usage interface 7 can be used to integrate to a separate system or file via real-time or batch processing to gather actual usage of a new innovation or change.

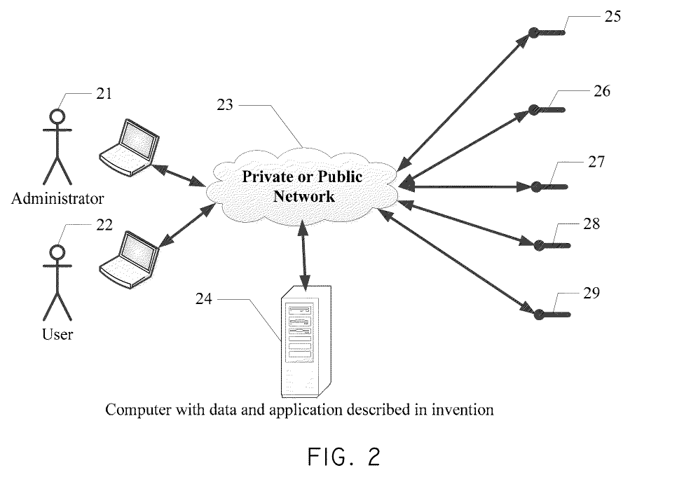

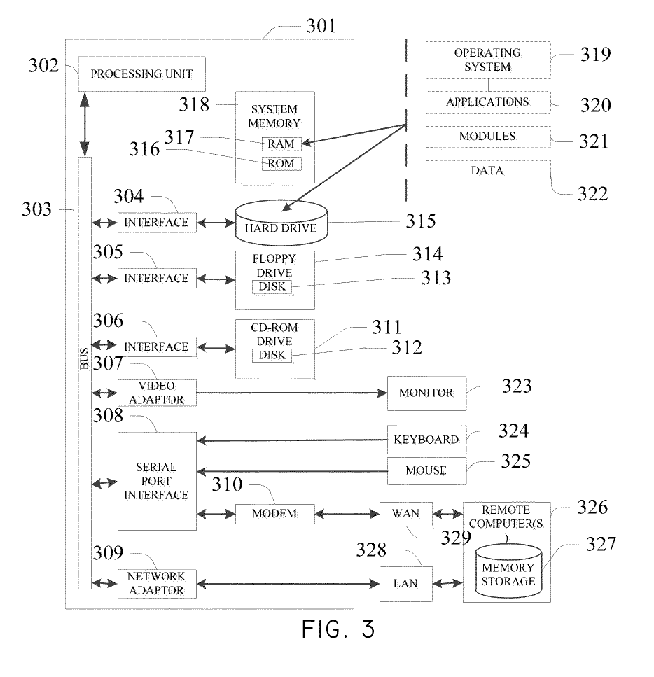

Referring now to an embodiment in more detail in FIG. 2 there is shown a computer network view. In FIG. 2 there is shown an administrator role 21, a user role 22, interacting via a private or public network 23 used for connecting the different participants and components, a computer with the data and application 24 as described in FIG. 3, an external data interface 29, an external statistics interface 28, an external survey tool interface 27, and external social network analysis interface 26, and an external change/innovation usage interface 25.

In further detail, still referring to an embodiment in FIG. 2, the component that is an external data interface 29 can be used to integrate to an external system via real-time or batch file to access other participant attributes, connections, or affiliations. These can include email systems, social media applications such as Facebook or LinkedIn, HR systems or others.

In further detail, still referring to an embodiment in FIG. 2, the component that is an external statistics interface 28 can be used to run statistical processing such as perception descriptive statistics or regressions using a standard statistics package such as IBM's SPSS.

In further detail, still referring to an embodiment in FIG. 2, the component that is an external survey tool interface 27 can be used to gather perceptions, network connections, and other attributes directly from participants 22.

In further detail, still referring to an embodiment in FIG. 2, the component that is an external social network analysis 26 can be used to perform social network analysis calculations, transformations, and render social network graphs.

In further detail, still referring to an embodiment in FIG. 2, the component that is an external change or innovation usage interface 25 can be used to integration to a separate system or file via real-time or batch processing to gather actual usage of a new innovation or change.

FIG. 3 illustrates one possible hardware configuration of systems and to implement methods described herein. It is to be appreciated that although a standalone computing architecture is illustrated, that any suitable computing environment can be employed in accordance with some embodiments. For example, computing architectures including, but not limited to, stand alone, multiprocessor, distributed, client/server, minicomputer, mainframe, supercomputer, digital and analog can be employed in accordance with some embodiments.

With reference to FIG. 3, an exemplary environment for implementing various aspects of the intention includes a computer 301, including a processing unit 302, a system memory 318, and a system bus 303 that couples various system components including the system memory to the processing unit 302. The processing unit 302 can be any of the various commercially available processors. Dual microprocessors and other multi-processor architectures also can be used as the processing unit 302.

The system bus 303 can be any of the several types of bus structure including a memory bus or memory controller, a peripheral bus, and a local bus using any of a variety of commercially available bus architectures. The computer memory 318 includes read only memory (ROM) 316 and random access memory (RAM) 317. A basic input/output system (BIOS), containing the basic routines that help to transfer information between elements within the computer 301, such as during startup, can be stored in ROM 316.

The computer 301 can further include a hard disk drive 315, e.g., to read from or write to a removable disk 314, and an optical disk drive 311, e.g., for reading a CD-ROM disk 312 or to read from or write to other optical media. The hard disk drive 315, magnetic disk drive 314, and optical disk drive 311 are connected to the system bus 303 by a hard disk drive interface 304, a magnetic disk drive interface 305, and an optical drive interface 306, respectively. The computer 301 can include at least some form of computer readable media. Computer readable media can be any available media that can be accessed by the computer 301. By way of example, but not limited to this example, computer, readable media, and communication media. Computer storage media includes volatile and nonvolatile, removable and non-removable media implemented in any method or technology for storage of information such as computer readable instructions, data structures, program modules or other data. Computer storage media includes, but is not limited to RAM, ROM, EEPROM, flash memory or the memory technology, CD-ROM, digital versatile disks (DVD) or the magnetic storage devices, or any other medium which can be used to store the desired information and which can be accessed by the computer 301. Communications media can include computer readable instructions, data structures, program modules or other data in a modulated data single such as carrier wave or other transport mechanism and includes an information delivery media. The term “modulated data signal” means a signal that has one or more of its characteristics set or changed in such a manner as to encode information in the signal. By way of example, and not limitation, communication media includes wired media such as wired network or direct-wired connection, and wireless media such as acoustic, RF, infrared and other wireless media. Combinations of any of the above can also be included within the scope of computer readable media.

A number or program modules can be stored in the drives and RAM 317, including an operating system 319, one or more application programs 320, other program modules 321, and program non-interrupt data 322. The operating system 319 in the computer 301 can be of any of a number of commercially available operating systems.

A user can enter commands and information in the computer 301 through a keyboard 324 and a pointing device such as a mouse 325. Other input devices (not shown) including a microphone, an IR remove control, a joystick, a game pad, a satellite dish, a scanner, or the like. These and other input devices are often connected to the processing unit 302 through a serial port interface 308 that is coupled to the system bus 303, but can be connected by other interfaces, such as a parallel port, a game port, a universal serial bus, a IR interface, etc. A monitor 323, or other type of display device, can be also connected to the system bus 303 via an interface, such as a video adapter 307. In addition to the monitor, a computer can include other peripheral output devices (not shown), such as speakers, printers etc.

The computer 301 can operate in a networked environment using logical and/or physical connections to one or more remote computers, such as remote computer(s) 326. The remote computer(s) 326 can be a workstation, a server's computer, a router, a personal computers, microprocessor based entertainment appliance, a peer device or other common network node, and can include many or all of the elements described relative to the computer 301, although, for purposes of brevity, only a memory storage device 327 is illustrated. The logical connections depicted include many or all of the elements described relative to the computer 301, although, for purposes of brevity, only a memory storage device 327 is illustrated. The logical connections depicted include a local area network (LAN) 328 and a wide area network (WAN) 329. Such networking environments are commonplace in offices, enterprise-wide computer networks, intranets, and the Intranet.

When used in a LAN networking environment, the computer 301 can be connected to the local network 328 through a network interface or adapter 309. When used in a WAN networking environment, the computer 301 can include a modem 310 (or functionally similar device), or can be connected to a communications server on the LAN, or has other means for establishing communications over the WAN 329, such as the Internet. The modem 310, which can be internal or external, can be connected to the system bus 303 via the serial port interfaces 308. In a networked environment, program modules depicted relative to the computer 301, or portions therefor, can be stored in the remote memory storage device 327. It will be appreciated that the network connections shown are exemplary and other means of establishing a communications link between the computers can be used.

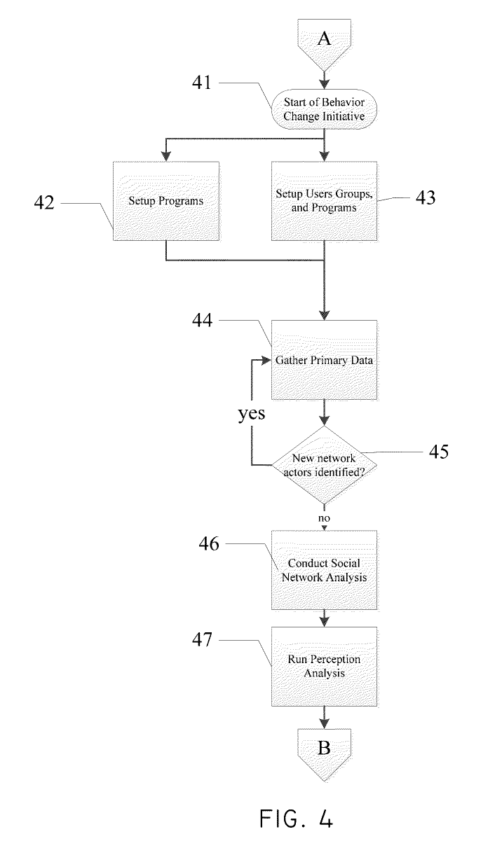

Referring now to an embodiment in more detail in FIG. 4 there is shown a flowchart of an exemplary order, but not the only order, of using an embodiment for the assessment of the change, innovation, or new technology initiative. FIG. 4 shows the start of an initiative to manage a behavior change initiative 41, an operation to setup and manage program/campaigns 42, an operation to setup and manage participants/groups/attributes 43, an operation to gather primary data 44, a decision operation to survey new network actors 45, an operation to run social network analysis 46. In more detail, still referring to an embodiment in FIG. 4, the database 2 contains, but is not limited to, the necessary data to execute the functionality of the operations 8 to 19 which could include, but is not limited to, participants, groups, participant attributes, change/innovation perceptions, social network connections which are also referred to as dyads, participant network attributes such as centrality or group membership. The database 2 could also contain a repository of training, communications, facilitating conditions and their impacts.

In further detail, still referring to an embodiment in FIG. 4, the operation to manage programs/campaigns 42 has the functionality, but is not limited to, manage template of different types of changes or new innovation initiatives which could act as starting points for planning, simulation, managing, and monitoring. This operation to manage programs or campaigns 42 also allows the section of permissions and access for participants of the system for a particular program or campaigns.

In further detail, still referring to an embodiment in FIG. 4, the operation to manage participants, groups, and attributes 43 can be used to allow creating, viewing, updating, and deleting of the participants who are targeted for the new change or innovation. This also includes removing duplicates or managing additional previously unknown participants who were forwarded a survey or identified during the process of gather primary connection data from the targeted participants of the innovation or change.

In further detail, still referring to an embodiment in FIG. 4, the operation to gather primary data 44 can be used to gather perceptions, network connections, and actual usage information. The perceptions could include the ability to configure online surveys to gather perceptions using previously validated or new scales based on for areas such as usefulness, ease of use, social influence, or habits, behavioral intention and actual usage. The network connections could include survey questions asking for whom the individuals they go to for different modes such as help, information, resources and others. Actual usage of a system could gather in this section via a survey question, manually entering it or a file import or integration to a separate system such as usage logs.

In further detail, still referring to an embodiment in FIG. 4, the operation to gather primary data 44 can be also able to track responses, view respondents, or offer incentives to complete the survey, and manage messaging. Because all the connections or targeted participants for a change or innovation initiative might not be known at the beginning of the initiative, there can be a decision operation 45 also includes functionality to configure “snowball survey” options, which essentially allows the system to allow participants to identify connections to originally non-targeted participants (i.e. outside of organization or target group) via the surveys, then follow up with an additional survey to the new connection or generate a list allowing an administrator to configure the new participant and send a new survey to them.

In further detail, still referring to an embodiment in FIG. 4, the operation to run social network analysis 46 can be used to create the social network models and their attributes based on the primary and other data available to the system. This could include factions of the organizations which were identified to bring close groups through change together (i.e. determine training groups). This analysis can also be used to determine networks, factions, opinion leaders, isolates, and network attributes such as centrality.

In further detail, still referring to an embodiment in FIG. 4, the operation to run perception analysis 47 can be used to run a statistical analysis of the perceptions of the group as well as merge the results with the social network analysis results. This allows the change or innovation planners to view the actual perceptions overlaid onto the social networks of the organization. This allows the participants to view the perceptions and actual usage of the innovation at an aggregate group or individual level. These perceptions are also used to determine the appropriate training and communication treatments. The system also calculates the perception metrics of a person's neighborhood to better predict their future usage

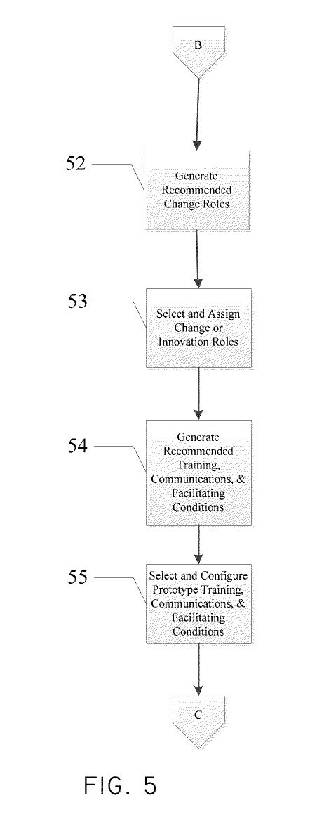

Referring now to an embodiment in more detail in FIG. 5 there is shown a flowchart of the recommendation and feedback operations within an embodiment, which would often happen as a continuation of the flowchart from FIG. 4 which shows an exemplary, but not the only order of using the invention. FIG. 5 shows an operation to generate recommend change roles 52, an operation to select and assign change/innovation roles 53, an operation to generate recommended training, communications & facilitating conditions 54, an operation to select and configure training, communications, and facilitating conditions 55.

In further detail, still referring to an embodiment in FIG. 5, the operation to generate change roles 52 can be used to identify subject matter experts or super-users based on their centrality of different network modes. For example, if there are certain people that everyone goes to for help, they would be an ideal candidate to be a subject matter expert. This operation can also recommend training groups based on the networks which allows tight-knit groups to go through acceptance or adoption of the change or innovation together. Isolates can be identified here, because their training and communications could be chosen based on their position. The system can also identify how to improve the network structure to increase the speed of change. For example align subject matter experts with isolates, build connections between groups such as team events. This operation can also recommend participants who should be targeted for communication or events like team-events to increase the number of connections they have for getting help, information, and knowledge around the change or innovation.

In further detail, still referring to an embodiment in FIG. 5, the operation to select and assign change and innovation roles 14 can be used to view the recommendations generated from operation 53, then make any adjustments to the assignments of subject matter experts, training & communication groups, and super-participants/isolate pairings. The system user can view opinion leaders and groups based on the social network analysis. This allows them to view who has the most influential power regarding multiple modes of the change (i.e. where do they go for help, who has access to resources, information, domain knowledge, or other modes). Those with high centrality should be incorporated as subject matter experts into the change or innovation initiative. This operation allows the system user to view groups, factions, and auto-generated suggested training groups.

In further detail, still referring to an embodiment in FIG. 5, the operation to generate training, communications, and facilitating conditions 54 can be used allow the system to auto-generate training and communication plans. The system chooses the best communication and training options based on the program template which includes prior research and similar initiatives. The objective is to generate appropriate communication and training for each individual and groups to maximize intention and usage where each participant could be different based on their individual current perceptions, group membership, centrality in the network, and moderating effects such as experience, and voluntariness of the change or innovation.

In further detail, still referring to an embodiment in FIG. 5, the operation to select and configure training, communications, and facilitating conditions 55 can be used to view the recommendations from the system and select from list of training and communication treatments which have be shown to impact participant's perceptions, intentions, and usage. The potential impact of the communication and training options are based on prior published research, previous calibration via testing, or expert estimate. Impacts are categorized similar to the main constructs for change and innovation acceptance based on published research, previous testing, or expert estimate (usability, ease of use, facilitating conditions, social influence, habits). The system user can select from a list of facilitating conditions offered (help desk, online help, and others). New training options, communications, training and facilitating conditions can also be added by the system user. This is applicable in some embodiments because most large technology companies will have suggested roll-out activities. This could also include configuring incentives, such as giving an incentive to the first segment of participants that go through training To facilitate simulation of the acceptance of this change or innovation later, the timing of the training, communications, or facilitating conditions are entered.

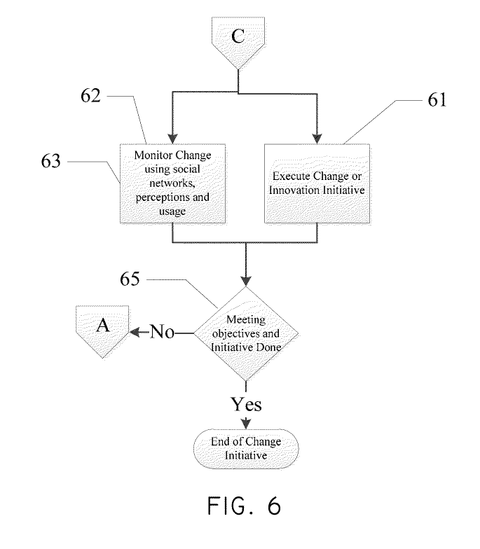

Referring now to an embodiment in more detail in FIG. 6 there is shown a flow chart of exemplary implementation operations which could be seen in an exemplary usage further to FIG. 5, but not the only order of using the invention. FIG. 6 shows an operation to an operation to monitor change using social networks, perceptions and usage data 63 which can be done in parallel with the execution of the change, innovation or new technology initiative. FIG. 6 also shows a decision operation 65, where the larger process can be repeated if the initiative is not done or the results are not meeting the objectives.

In further detail, still referring to an embodiment in FIG. 6, the operation to monitor the change or innovation initiative 61 can be used to view integrated social network views integrated in a way such as color-coded with relevant change metrics which could include usage, perceptions, effectiveness of communications and training treatments based on the most current data. Periodic surveys are one way that a current status is maintained of the perceptions and usage. Actual system usage logs of a new technology or innovation are another source of information for these dashboards that could imported through an external data interface 3 from FIG. 1.

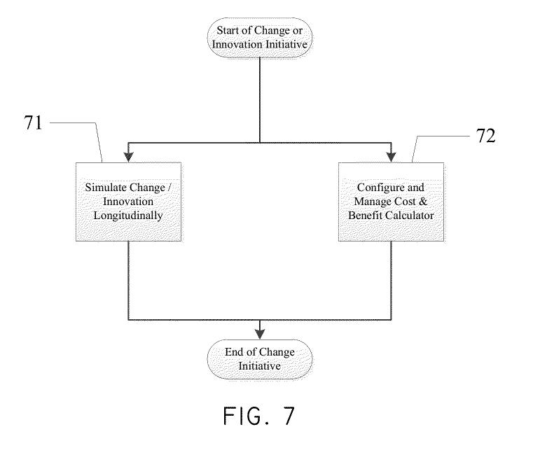

Referring now to an embodiment in more detail in FIG. 7 there is shown a flow chart of an implementation of operations which could be seen in an exemplary usage further to FIG. 6, but not the only order of using the invention. FIG. 7 shows an operation to simulate change/innovation acceptance longitudinally over time 71 and an operation to manage a cost and benefit calculator 72.

In further detail, still referring to an embodiment in FIG. 7, the operation to simulate change and innovations longitudinally over time 71 can be used to quickly simulate multiple change and communication plans over-time across the networks and view the effectiveness of the different plans. In configuring the scenario for simulations, the system user can configure the target perceptions, intention, and usage which would be considered acceptable for success of the effort. This allows the system user to adjust communication, training, or facilitating conditions as needed until they are satisfied with the results. The simulations could take into account the particular subject matter experts, change in perceptions over a series of times steps, network neighbor perceptions, network neighbor intentions, network neighbor usage, training, communications, centrality, moderating affects, facilitating conditions, and factors that have been show through multiple regression or other statistical regression analysis to impact the usage, perceptions, and behavioral intentions of participants. The simulations can be re-run to test multiple scenarios based on a range of a particular variable or configuration (i.e. how much hand-on training to conduct)

In further detail, still referring to an embodiment in FIG. 7, the operation to calculate the changing cost and benefit of the change or innovation initiative 72 can be used to calculate the return on a cost-benefit comparison of the overall change or innovation initiative. This calculation uses the communication, training, and facilitating condition treatments costs and additional participant entered data such as benefits, participant hourly costs, and others.

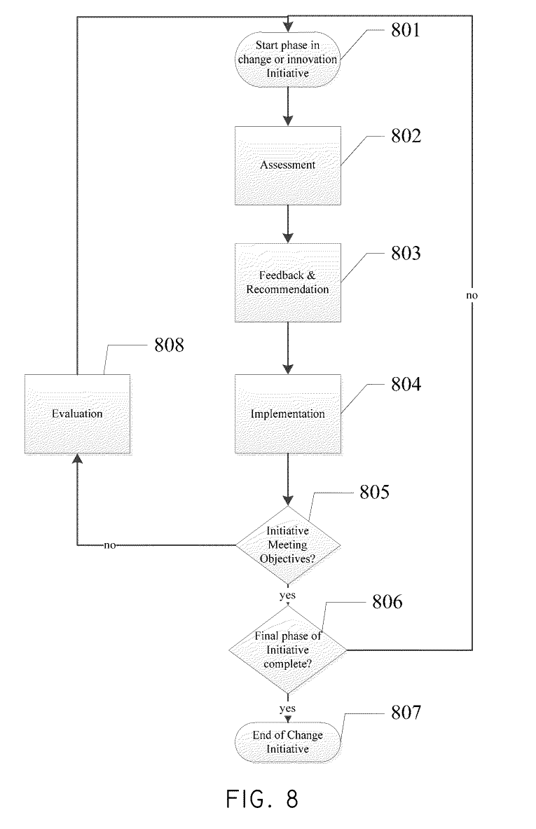

Referring now to an embodiment in more detail in FIG. 8 there is shown a high level flow chart of the overall intention that describes an exemplary order of the groups of operations shown in FIGS. 4-7. This is an exemplary order, but not the only order contemplated of these larger groups of operations. What is shown is a step showing the start a change or innovation initiative 801, an operation to complete the assessment 802, which is detailed in FIG. 4, an operation to complete the feedback and recommendation, which is detailed in FIG. 5, an operation to complete the implementation, which is detailed in FIG. 6, a decision operation to determine if an evaluation is necessary which 805, an operation to iterate through the larger process if there are additional phases or iterations 806, and an operation to complete the evaluation operations as detailed in FIG. 7.

In more detail, still referring to an embodiment in FIG. 8, which is a simplified example of business process flow in using the system to assess 802, provide feedback and recommendation 803, support the implementation 804, and evaluate the larger change 808, he interfaces 3, 4, 5, 6, and 7 detailed in FIG. 1 could also be used in conjunction with its appropriate needs of various operations such as the cost and benefit calculator 72 which could be used iteratively throughout the process. These components can be used in a serial fashion in some embodiments, but one familiar with change management or acceptance of new innovations, will appreciate the iterative dynamics of planning and executing these initiatives and usage of the functionality.

Some embodiments can achieve better planning, management, predictive simulation, and monitoring of adoption on acceptance of one or more significant change or new innovation initiatives. Some embodiments can maximize the cost and benefit, increase the responsiveness of the participants to adopt innovations and change, and minimize the likelihood of failure of change or innovation programs. Some will allow change management and innovation planners to optimize their plan via predictive simulations. Some embodiments can allow for active monitoring of the effectiveness of the behavioral change initiative so corrective actions can be taken quickly if necessary. Some embodiments can operationalize the complex social network and psychological dynamics of innovation and change acceptance into a system that is usable by the practitioners or planners managing change and innovations. It can make recommendations for many of the key decisions around change and innovation initiatives for the system user such as choosing subject matter experts and suggesting the appropriate communication and training treatments for a particular type of change.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular state of configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

1. A method for accelerating or improving the success rate of a behavior change, the method comprising:
gathering primary and secondary relationship data of an informal network of individuals and behavior change constructs for a plurality of individuals within the informal network of individuals;
performing social network analysis of the informal network with a computing system using the gathered primary and secondary relationship data and behavior change constructs; and
performing the statistical perception analysis of the individuals within the informal network using gathered primary and secondary relationship data and behavior change constructs;
wherein the behavior change constructs include at least one of change perception, behavior intention, and behavior measures.

2. The method of claim 1, further comprising using a template for a specific behavior change initiative, the template including relevant behavior change constructs and needed measures to gather the primary relationship data.

3. The method of claim 2, the template comprising behavior change constructs selected from the group consisting of perceived usefulness, perceived ease of use, habit, social norm, facilitating conditions, performance expectancy, effort expectancy, pride, job performance, engagement, system usage, behavioral intention, extra-role behavior, economic outcomes, job satisfaction, job characteristics, organizational commitment, dedication, supervisory support, perceived autonomy, job resources, personal resources, wellness, loyalty, creative self, coping self, social self, essential self, physical self and enjoyment expectancy.

4. The method of claim 1, further comprising identifying previously unknown individuals within the primary relationship data to automatically expand the informal network boundaries of the behavior change initiative.

5. The method of claim 4, wherein identifying previously unknown individuals is accomplished through a snowball survey method.

6. The method of claim 1, further comprising using the performed social network analysis measures as part of the perception analysis.

7. The method of claim 1, further comprising using the performed perception analysis results as part of the social network analysis.

8. The method of claim 1, further comprising
estimating the cost of the behavior change initiative based on treatments used to effect the behavior change;
estimating the benefits of the behavior change initiative based on the adoption of the behavior; and
generating a financial metric of the degree of success of the behavior change initiative using the estimated cost and benefits of the behavior change initiative.

9. The method of claim 1, further comprising generating recommended treatments to achieve the behavior change based the social network analysis and perception analysis.

10. The method of claim 9, wherein the recommended treatments are at the group or individual level.

11. The method of claim 9, wherein the recommended treatments are selected from a palette of treatments specific to the organization, community, or type of behavior change initiative.

12. The method of claim 11, wherein each of the treatments on the palette of treatments has quantifiable costs and defined impacts to behavior change constructs.

13. The method of claim 9, wherein recommended treatments are selected from the group consisting of interventions such as formal training, informal training, help-desks, communications, web-based training, incentive programs, key initiative roles, monetary incentives, tools, help-desks, subject matter experts, FAQ, manuals, kick-off events, live web training events, games, mentoring, team events, dedicated training time, tips & tricks, lunch & learns, blogs, and knowledge sharing tools.

14. The method of claim 1, further comprising generating recommended change roles for individuals within the informal network of individuals to achieve the behavior change based the social network analysis and perception analysis.

15. The method of claim 14, wherein recommended change roles are selected from the group consisting of subject matter experts, super-users, recommended training groups, and phased roll-out groups.

16. The method of claim 1, further comprising generating recommended connections between individuals within the informal network of individuals that would accelerate or improve the success rate of the behavior change initiative.

17. The method of claim 1, the behavior change constructs selected from the group consisting of perceived usefulness, perceived ease of use, habit, social norm, facilitating conditions, performance expectancy, effort expectancy, pride, job performance, engagement, system usage, behavioral intention, extra-role behavior, economic outcomes, job satisfaction, job characteristics, organizational commitment, dedication, supervisory support, perceived autonomy, job resources, personal resources, wellness, loyalty, creative self, coping self, social self, essential self, physical self and enjoyment expectancy.

18. The method of claim 1, further comprising simulating the informal network structure and behavior change perceptions of the behavior change initiative at multiple future time points.

19. The method of claim 18, wherein simulating is performed using the results of the statistical perception analysis and data regarding expected quantifiable behavior change impacts of treatments.

20. The method of claim 19, wherein the data regarding expected quantifiable behavior change impacts of treatments is based on prior published quantitative research, previous calibration via testing, or expert estimates.

21. The method of claim 18, wherein simulating includes the variables that are part of a behavior change conceptual model.

22. The method of claim 21, the variables selected from the group consisting of perceived usefulness, perceived ease of use, habit, social norm, facilitating conditions, performance expectancy, effort expectancy, pride, job performance, engagement, system usage, behavioral intention, extra-role behavior, economic outcomes, job satisfaction, job characteristics, organizational commitment, dedication, supervisory support, perceived autonomy, job resources, personal resources, wellness, loyalty, creative self, coping self, social self, essential self, physical self and enjoyment expectancy.

23. The method of claim 18, wherein simulating includes varying the timing and quantity of the treatments.

24. The method of claim 18, wherein simulating includes performing a series of sensitivity tests related to individual treatments in order to optimize the selection, timing and quantity of treatments to maximize the speed of change, maximize the benefits, or minimize the cost of the behavior change initiative.

25. The method of claim 18, wherein simulating including modeling the effects of changing connections within the informal social network.

26. The method of claim 1, further comprising monitoring the behavior perceptions, informal networks, the effects of the treatments, and the estimated costs and benefits.

27. The method of claim 25, further comprising generating change metrics using behavior perceptions, informal networks, the effects of the treatments, and the estimated costs and benefits.

28. The method of claim 25, wherein monitoring includes generating social network graphs at different times which can be color-coded based on behavior constructs or usage.

29. The method of claim 25, wherein monitoring comprising generating dashboards.

30. The method of claim 25, wherein monitoring including measuring aspects of the informal social network including one or more of network density, centrality, paths, structural holes, number of groups, diameter, cliques, and number of actors.

31. The method of claim 25, further comprising gathering updated primary and secondary relationship data of an informal network of individuals and updated behavior change constructs for a plurality of individuals within the informal network of individuals at future time intervals.

32. The method of claim 1, further compromising generating a cost-benefit analysis of the overall behavior change initiative.

33. The method of claim 32, wherein inputs for the cost-benefit analysis include costs of the behavior change initiative, costs of treatments and interventions, participant entered cost-benefit data, quantifiable perception benefits, financial benefits of the behavior change initiative and participant hourly costs.

34. A system for accelerating or improving the success rate of a behavior change initiative in an organization, group or community, the system comprising:
a processor; and
memory in operative communication with the processor;
the system configured to process as input primary and secondary relationship data of an informal network of individuals and behavior change constructs for a plurality of individuals within the informal network of individuals;
the system configured to perform social network analysis of the informal network using the gathered primary and secondary relationship data and behavior change constructs; and
the system further configured to perform perception analysis of the individuals within the informal network using the gathered primary and secondary relationship data and behavior change constructs;
wherein the behavior change constructs include at least one of change perception, behavior intention, and behavior measures.
